(19) United States
(12) Patent Application Publication
(10) Pub. No.: US 2008/0117028 A1
(43) Pub. Date: May 22, 2008

(54) RFID ASSISTED CALIBRATION SYSTEM

(75) Inventor: Christopher Kent Karstens, Apex, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/562,484

(22) Filed: Nov. 22, 2006

(51) Int. Cl. H04Q 5/22

(52) U.S. Cl. 340/10.51

(57) ABSTRACT

A method for the real-time calibration of a system by the use of integrated RFID-enabled system components. The method comprises the steps of scanning a system for integrated RFID-enabled system components by use of an RFID tag reader to identify the RFID-enabled system component; utilizing the RFID tag reader to acquire the object characteristic information in regard to the RFID-enabled system component from the RFID tag of the system component; storing the RFID tag identifier and the associated system component object characteristic information if a database; and transmitting the acquired object characteristic information in regard to the RFID-enabled system component to a control unit, wherein the object characteristic information is used by the control unit to ascertain the pre-specified performance criteria of the system component, and thereafter, the control unit utilizes the ascertained performance criteria of the system component to define and establish the performance criteria of the system.

### BACKGROUND OF THE INVENTION

1. Field of the Invention

This invention relates to the system monitoring techniques and particularly to the monitoring and inventory of the performance characteristic of system components by the use of RFID technology.

2. Description of Background

Before our invention in the event that components within a system wore out or failed, replacement parts for the system could be chosen from inventories that encompassed factory new replacement parts, or aftermarket replacement parts manufactured by third parties to serve in lieu of a factory manufacture's parts. Whatever the origin of a part, the replacement part is manufactured to meet or exceed specified performance requirements. However, not all replacement part manufacturers produce similar parts that meet the same system specified requirements for a part, therefore parts that are replaced within a system may not have been manufactured to the same performance specification as the replaced part, and therefore the replacement part may potentially alter the overall performance productivity of the system.

### SUMMARY OF THE INVENTION

The shortcomings of the prior art are overcome, and additional advantages are provided through the provision of a method for the real-time calibration of a system by the use of integrated RFID-enabled system components. The method comprises the steps of associating an RFID tag identifier with a system component, associating specified component characteristic information regarding a component within the RFID tag that is associated with the component, and physically integrating the RFID tag with the system component in order to produce an RFID-enabled system component.

The method further comprises the steps of scanning a system for integrated RFID-enabled system components, utilizing an RFID tag reader to identify the RFID-enabled system component, utilizing the RFID tag reader to acquire the object characteristic information in regard to the RFID-enabled system component from the RFID tag of the system component, and storing the RFID tag identifier and the associated system component object characteristic information is a database. The acquired object characteristic information in regard to the RFID-enabled system component is transmitted to a control unit, wherein the control unit to ascertain the pre-specified performance criteria of the system component uses the object characteristic information. Thereafter, the control unit utilizes the ascertained performance criteria of the system component to define and establish the performance criteria of the system.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a RFID enabled component scanning system.

FIG. 2 illustrates the details of a flow diagram for the scanning of RFID enabled components within a system.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only, since numerous modifications and variations therein will be apparent to those of ordinary skill in the art. In reference to the drawings, like numbers will indicate like parts continuously throughout the view.

A purpose of the present RFID enabled component scanning system is to gather performance data in regard to specific system components, and thereafter utilized this gathered data to calibrate the system in order to ensure that the system operates in accordance with the gathered performance data. Specifically, system components are associated with RFID tags. The RFID tags comprise tag identification information and additional information that details specified performance characteristic of a particular component.

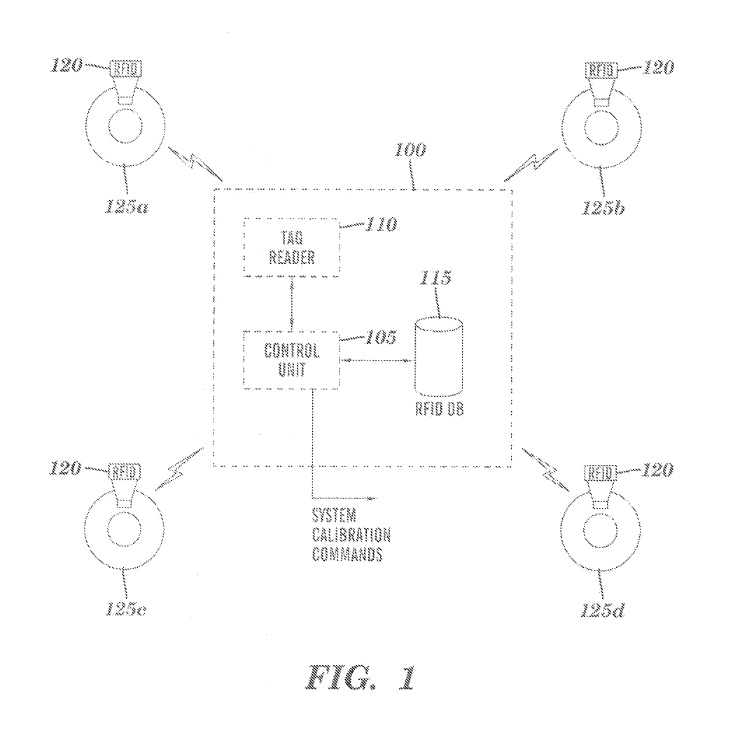

Turning now to the drawings in greater detail, it will be seen that in FIG. 1 there is a RFID enabled calibration system 100, wherein the system comprises a control unit 105, a RFID tag reader 110, a RFID database 115, and a RFID tag 120 that is integrated with a system component (in this instance the components are tires 125a-125d that are part of an automobile system that is not shown). Within aspects of the present invention, the control unit 105 receives RFID tag 120 information via the tag reader 110. The tag reader 110 is configured to detect and interrogate the RFID tag 120, wherein the information that is acquired by the use of the interrogation function is transmitted to the control unit 105.

Within aspects of the present invention the tag reader 110 comprises a transceiver, a decoder and an antenna mechanism that is configured to emit a signal that activates the RFID tag 120 so that data contained within the RFID tag 120 can be read. The reader 110 decodes the data that is encoded within the RFID tag's 120 integrated circuitry, and transmits the data to the control unit 105. The control unit 105 performs a reference check to confirm that the data that is associated with a system component item is not already stored, by accessing the database 115 in order to determine if the information pertaining to a particular component has already been stored. In the event that the reference identification and accompanying data for a system component are not referenced within the database 115, the control unit will store the appropriate reference information regarding the component data at the database 115. Lastly, the control unit 105 processes the extracted component part data and utilizes the information from the data to set performance standards for the overall system application.

Additional aspects of the present invention allow not only for the reading of information from a RFID tag 120, but also allow for either the system, or component to write data to the memory of a RFID tag 120 as well. For example, a RFID enabled tag 120 may have a read only section of the RFID chip memory that stores the identifier for the RFID tag 120. However, another section of the chip may be dedicated to either a write only or read/write memory. The write only, or read/write memory section can subsequently be use to aid, and enhance the functional operations of systems and components.

For example, assume that a system scan is performed of all of the integrated system components, during which scanning operation the system determines that all components of a particular type will operate at a specified setting. Thereafter, the system can be configured to write the specified operational setting to each of the RFID tags 120 that are integrated into the components of the particular determined type. Thus, when the components are activated, they can be configured to read the operational setting value that has been written to the RFID tag 120, and accordingly set their internal operational adjustments. This aspect of the present invention is of particular use in the event that a system/controller cannot otherwise adjust the individual settings on respective system components.

Accordingly, in a further example, a component itself may update an operational section of a system during runtime in the instance where a component is configured to capture specific data, or sensor data. In aspects of the present invention, the component may update the write only or read/write memory of the RFID tag 120 with captured data in real-time. Thereafter, the data that has been written to the RFID tag's 120 memory can be extracted by the system, and thereafter used to assist in calibrate operational functions of the system. This aspect is extremely useful in the event that the component cannot otherwise communicate with the system/controller.

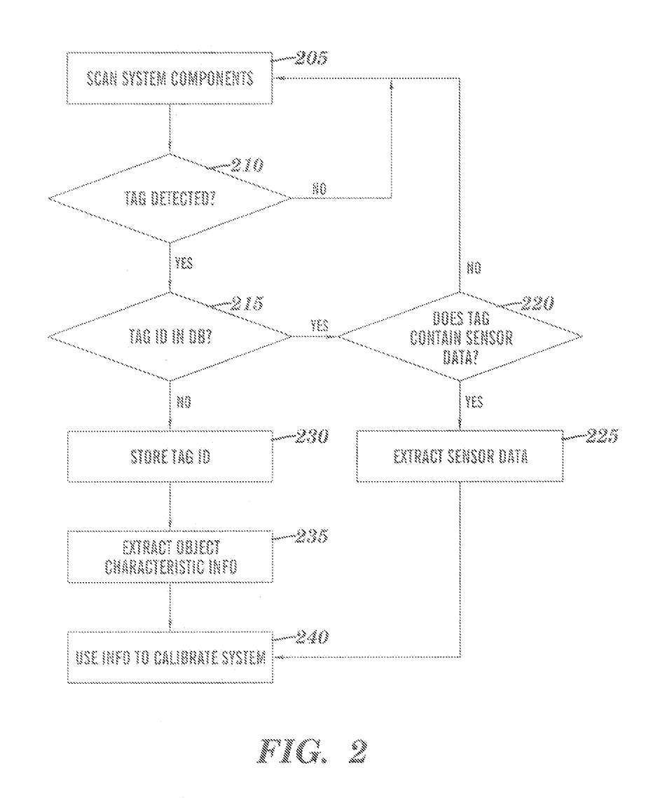

FIG. 2 shows a flow diagram that details a method for scanning a system for integrated RFID-enabled system components. At step 205, a system can for integrated RFID-enabled system components is initiated by the control unit 105 transmitting a command to the tag reader 110 to emit a signal that activates the RFID tags 120 of system integrated components. At step 210 a determination is made as to whether a RFID tag 120 has been detected, if no tags are detected then the system continues to scan for RFID tags 120 for a pre-specified time period. In the event that a RFID tag 120 is detected, then at step 215, a determination is made as to whether the RFID tag 120 identifier and any accompanying RFID tag object specific data is referenced in the database 115. If the information is already stored then, at step 220, the system will interrogate the RFID tag 120 in order to determine if the tag has any additional information (e.g., updated sensor data) stored in its memory. If the RFID tag 120 is determined not to have any updated stored information then the system returns to the system scanning operation of step 205. If the RFID tag 120 is determined to have updated stored information, then the updated information is extracted from the RFID tag 120 and utilized by the system to establish the performance criteria for the system (step 240).

In the event that the RFID tag 120 identifier is not currently stored, then the system acquires the component identifier information (step 230), and thereafter acquires and stores the object characteristic information (step 235) in regard to the RFID-enabled system component from the RFID tag 120. At step 240 the acquired RFID-enabled system component characteristic information is received at the control unit 105, wherein the control unit 105 to ascertain the pre-specified performance criteria of the system component uses the component characteristic information. Thereafter, the control unit utilizes the performance criteria of the system component to define and establish the performance criteria for the system.

Within aspects of the present invention the RFID tags 120 comprise a transponder having a digital memory chip that is assigned a unique tag identifier. The RFID tag 120 may be configured to be either a passive or active RFID tag. As the name implies, passive RFID tags do not comprise an internal power source, however the tags do comprise an antenna mechanism for the transmission and reception of signals. The source of power for a passively configured RFID is provided via an electric current, wherein the electric current is induced in the antenna by incoming radio frequency signals that are transmitted from a RFID interregator/reader.

The induced current provides enough power to the tag to activate the RFID tag 120, and transmit a response to the incoming signal. The response to the incoming signal includes data that represents the tag ID number. Further, in the instance that a tag comprises memory, then additionally stored data may be transmitted with the accompanying tag identification data. Conversely, active RFID tags comprise an internal power source that independently can provide enough power to generate an outgoing signal. Active RFID tags have the capability to integrate sensors (e.g., temperature, air pressure, etc . . . ) within their mechanisms, thus providing enhanced feedback performance information in regard to a specific item to which the RFID is attached.

The digital memory chips that are comprised within RFID tags, as utilized within aspects of the present invention, can either be read-only, or read/write memory chips. Typically, read-only memory chips have identification information that is stored on the chip during a manufacturing process. Therefore, the information that is stored on the chips cannot be altered. Conversely, read/write memory chips are dynamic data carriers, meaning that the information that is stored on the RFID tag can be supplemented or deleted. Existing information can be overwritten on a RFID tag, or information can be added to the tag in the event that the RFID tag is in proximity to a RFID tag reader. Conventionally, read/write RFID tags comprise a section of memory that is read-only. This read-only memory section typically stores the RFID identifier, and as such, the information cannot be overwritten.

As mentioned above, the RFID enabled system components allow a system to dynamically calibrate itself in real-time specifically based upon the data that is gathered from the component parts that are installed within the system. The aspect of the invention allows for a system operator to safely enhance or degrade the performance of a system by the use of factory specified or aftermarket component parts.

### Example Scenario 1

Currently, heat sinks that are utilized within computing systems are constructed from a variety of materials and come in assorted sizes and shapes. Therefore, simply because two heat sinks may look the same does not mean they will possess the same thermal characteristics, or properties. For example, a system operator is presented with two identical looking heat sinks, heat sink 1 and heat sink 2, wherein heat sink 1 possesses a thermal level of 25, while heat sink 2 possesses a thermal level of 100 (assume “thermal level 0” represents a heat sink with very weak capabilities, and “thermal level 100” represents a heat sink with very strong capabilities). In accordance with aspects of the present invention, a computer system can be equipped to scan its internally integrated/connected component parts as part of the power-on self-test function. When the computer system detects a CPU, it will accordingly expect to detect a heat sink for CPU. If the heat sink is missing, or a heat sink without affixed RFID tag 120 has been installed, the system will not start and may log an error indication, or illuminate a fault LED to alert a system operator.

If the system determines that performance specification indicate that a thermal level 25 heat sink has been installed, then accordingly, the system may degrade the CPU's performance levels to where the CPU can safely operate with a thermal level 25 heat sink. In the event that the CPU performance level cannot be throttled down to accommodate the thermal level 25 heat sink component part, then the system may not start, and may generate an error indication.

### Example Scenario 2

Automobile tires come in differing sizes, and tread patterns. Because two tires look the same does not mean they possess the same performance, handling, safety, load rating, or heat dissipation characteristics. The operational performance specifications of a tire that are stamped on the tire sidewall can be represented in RFID data that is associated with a RFID tag that can be affixed to a tire wall. Assume that an automobile owner has four factory 125 MPH Class A tires installed on his car. When the owner is operating the vehicle at 100 MPH (or 80% of 125 MPH), a warning lamp notifying the driver of his current speed, or a speed-limiting device may be activated to keep the vehicle operating within predetermined performance specifications. These actions may be implemented in order to keep the operator from losing control of the vehicle.

Further assume that the vehicle gets a flat tire, and the owner replaces the flat tire with a tire that is an 85 MPH Class B tire. Within aspects of the present invention, the automobile system is equipped to scan for all RFID enabled system components. Upon the completion of a system scan, the system determines that the lowest speed tire installed on the vehicle in terms of MPH capabilities is the 85 MPH Class B tire. In this instance, the performance characteristics of the vehicle will be recalibrated, and now at 68 MPH (or 80% of 85), the vehicle operator will receive a speed warning signal, or a speed-limiting device will be enabled.

### Example Scenario 3

Assume that a spare tire has been installed on a vehicle, wherein the spare tire may not be driven over 30 MPH, or for more that 3,000 miles. When the spare is installed on the vehicle, the vehicle system can scan the spare tire and thereafter dynamically limit the capability of the automobile to go no faster than 30 MPH. Further the system can be configured to track and log the mileage for the particular tire's performance within the vehicle system, utilizing the tire's unique identification information that has been associated with the tire, over the life of the tire. For instance, the driver may receive a warning around 2900 miles on the particular spare tire that the spare tire is about the reach its maximum safe mileage capacity. Thereafter, the automobile may not start when the tire is re-fitted and has over 3,000 miles that are logged in the system.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A method for the real-time calibration of a system by the use of integrated RFID-enabled system components, the method comprising the steps of:
associating an RFID tag identifier with a system component;
associating specified component characteristic information regarding a component within the RFID tag that is associated with the component;
physically integrating the RFID tag with the system component in order to produce an RFID-enabled system component, wherein the RFID tag comprises a memory storage component, the memory storage component further comprising stored object characteristic information in regard to the system component;
scanning a system for integrated RFID-enabled system components by using an RFID tag reader to identify the RFID-enabled system component;
utilizing the RFID tag reader to acquire the object characteristic information in regard to the RFID-enabled system component from the RFID tag of the system component;
storing the RFID tag identifier and the associated system component object characteristic information in a database;
transmitting the acquired object characteristic information in regard to the RFID-enabled system component to a control unit, wherein the object characteristic information is used by the control unit to ascertain the pre-specified performance criteria of the system component, and thereafter, the control unit utilizes the ascertained performance criteria of the system component to define and establish the performance criteria of the system.

2. The method of claim 1, wherein the RFID tag comprises a write only memory component.

3. The method of claim 1, wherein the RFID tag comprises a read/write memory component.

4. The method of claim 1, wherein the RFID tag identifier and the associated object characteristic information in regard to the RFID-enabled system component are stored at a remote location.

5. The method of claim 1, wherein the RFID tag identifier and the associated object characteristic information in regard to the RFID-enabled system component are stored locally.

6. The method of claim 1, further comprising the step of periodically scanning the system for integrated RFID-enabled system components at pre-determined time intervals.

7. The method of claim 1, wherein the control unit monitors the performance history of an RFID-enabled system component within a system.

8. The method of claim 7, further comprising the step of saving the performance history data in regard to an RFID-enabled system component within a system at a database.

9. The method of claim 8, further comprising the step of periodically updating the performance history data of the RFID-enabled system component within the database.

10. The method of claim 9, further comprising the step of utilizing the performance history data of the RFID-enabled system component to assist in the step of defining and establishing the performance criteria of the system.

11. A computer program product that includes a computer readable medium useable by a processor, the medium having stored thereon a sequence of instructions which, when executed by the processor, causes the processor to calibrate a system by the use of integrated RFI-enabled system components in real-time, wherein the computer program product executes the steps of:
scanning a system for integrated RFID-enabled system components by using an RFID tag reader to identify the RFID-enabled system component;
utilizing the RFID tag reader to acquire the object characteristic information in regard to the RFID-enabled system component from the RFID tag of the system component;
storing the RFID tag identifier and the associated system component object characteristic information in a database;
transmitting the acquired object characteristic information in regard to the RFID-enabled system component to a control unit, wherein the object characteristic information is used by the control unit to ascertain the pre-specified performance criteria of the system component, and thereafter, the control unit utilizes the ascertained performance criteria of the system component to define and establish the performance criteria of the system.

12. The computer program product of claim 11, wherein the RFID tag comprises a write only memory component.

13. The computer program product of claim 11, wherein the RFID tag comprises a read/write memory component.

14. The method of claim 11, further comprising the step of periodically scanning the system for integrated RFID-enabled system components at pre-determined time intervals.

15. The method of claim 11, wherein the control unit monitors the performance history of an RFID-enabled system component within a system.

16. The method of claim 15, further comprising the step of saving the performance history data in regard to an RFID-enabled system component within a system at a database.

17. The method of claim 16, further comprising the step of periodically updating the performance history data of the RFID-enabled system component within the database.

18. The method of claim 17, further comprising the step of utilizing the performance history data of the RFID-enabled system component to assist in the step of defining and establishing the performance criteria of the system.
